(19) United States
(12) Patent Application Publication
(10) Pub. No.: US 2017/0027795 A1
(43) Pub. Date: Feb. 2, 2017

(54) SYSTEM AND METHODS FOR SAFE LIFTING OF PATIENTS FROM HOSPITAL BEDS

(71) Applicant: Farshid Asil, Newton, MA (US)

(72) Inventor: Farshid Asil, Newton, MA (US)

(21) Appl. No.: 15/219,206

(22) Filed: Jul. 25, 2016

Related U.S. Application Data
(60) Provisional application No. 62/196,333, filed on Jul. 24, 2015.

(51) Int. Cl. A61G 7/10

(52) U.S. Cl. CPC A61G 7/1032; A61G 7/1019; A61G 7/1046; A61G 7/1063

(57) ABSTRACT

Systems and methods are provided for safe lifting of patients from hospital beds, moving of patients, and lowering of patients into hospital beds, or other hospital or patient care facilities. The system comprises a frame configured to securely support, raise or lower, and move plates suitably sized to hold a person. The plates support the patient and guide conveyor belts, which are disposed on and around the plates. The frame holds rollers to guide and move the conveyor belts in forward and reverse directions, suited to moving the plates under a person and lifting a person from a bed, or returning a person to a bed. The present invention solves problems with the currently available means of moving people in or out of hospital beds or other patient-care locations, by making it easier for patient-care staff to move a patient, and reducing strain on the patient.

### FIELD OF THE INVENTION

The presently disclosed subject matter relates to lifting and moving of people, and more specifically, to systems and methods for safely lifting and lowering hospital patients and other people in beds in and out of beds, and moving those people easily.

### BACKGROUND OF THE INVENTION

Patients in hospital beds must be moved often, for reasons including but not limited to assessment and diagnosis, visits to other facilities, exercise, cleaning the patient, changing clothes, and cleaning and changing the bed. Patients are typically moved by nurses, orderlies, or other staff. According to Bureau of Labor Statistics (BLS), as reported by Centers for Disease Control and Prevention (http://www.cdc.gov/niosh/topics/safepatient/), rates of musculoskeletal injuries from overexertion in healthcare occupations are among the highest of all U.S. industries. BLS data show that the overexertion injury rate for hospital workers is twice the average for all workers, and for ambulance workers it is six times the average for all workers. Nurses and hospital support staff also suffered the greatest number of lost-time cases for general musculoskeletal pain and back pain.

The present invention offers a novel and safe system for mechanized lifting of patients in a safe and secure manner without requiring physical exertion by hospital staff.

Additionally, the current art of moving patients—by physically gripping the patient, or by lifting a sheet under the patient, or a reinforced pad under the patient—all can put considerable strain on the patient. The present invention discloses systems and methods for moving a patient that are safer and less disruptive to the patient.

### SUMMARY OF THE INVENTION

The present invention meets all these needs, by disclosing systems and methods for lifting patients out of hospital beds or other patient-care facilities, transporting patients between patient-care facilities, and lowering patients into hospital beds or other patient-care facilities. The goal of the present invention is to provide a solution for easier patient transport and lifting/lowering out of or into a bed. As the term “bed” is used in the present disclosure, it is to be understood to be construed broadly to mean any hospital bed or cot, or any other facility or piece of care equipment, diagnostic machinery, or other place that a patient might be placed or lifted from.

In the present invention, the disclosed systems enable patient-care workers to move a patient with little to no physical exertion by—and accordingly small risk of injury to—the patient care workers. At the same time, the present invention allows that moving of patients with much less strain on the patient, and lessened risk of injury to the patient.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a side elevation view of the present invention, including a schematic of a patient on a hospital bed.

FIG. 2 shows a side perspective view of the plates of the present invention with cutout views of the roller mechanisms, without the frame illustrated.

FIG. 3 shows a side perspective view of the frame of the present invention, without the plates or roller mechanism illustrated.

FIG. 4 shows a top elevation view of the present invention, depicting the frame, roller mechanisms, and plates.

FIG. 5 shows a side elevation cross-section of the present invention, depicting the roller mechanisms, the plates, and the conveyor belts.

FIG. 6 shows a front perspective view of the present invention, depicting the plates, the conveyor belts, and optional spacers between the plates.

FIG. 7 shows a front elevation view of the present invention, depicting the plates, the conveyor belts, and optional spacers between the plates.

FIG. 8 shows a top elevation view of the present invention, depicting the roller mechanisms, conveyor belts, plates, and locations of spacers.

FIG. 9 shows a schematic illustration of a method of operation of the inventive system.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the methods and systems of the present invention.

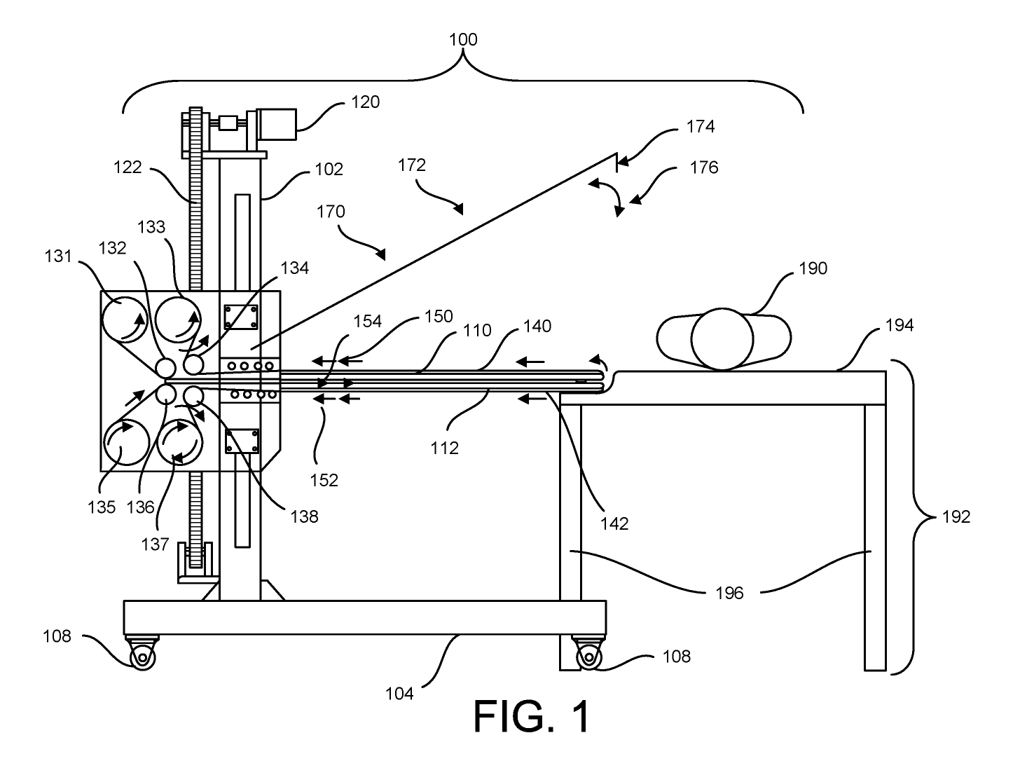

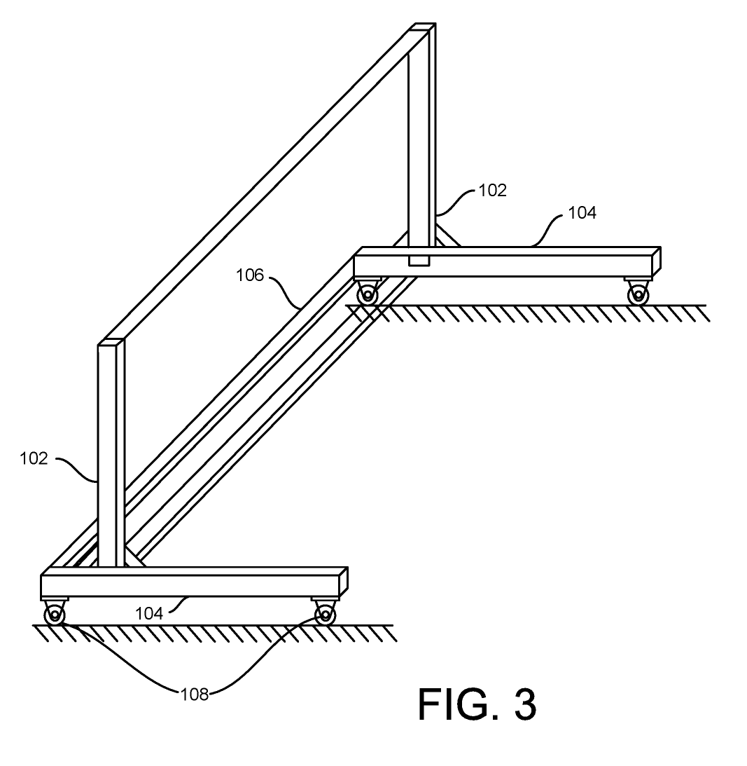

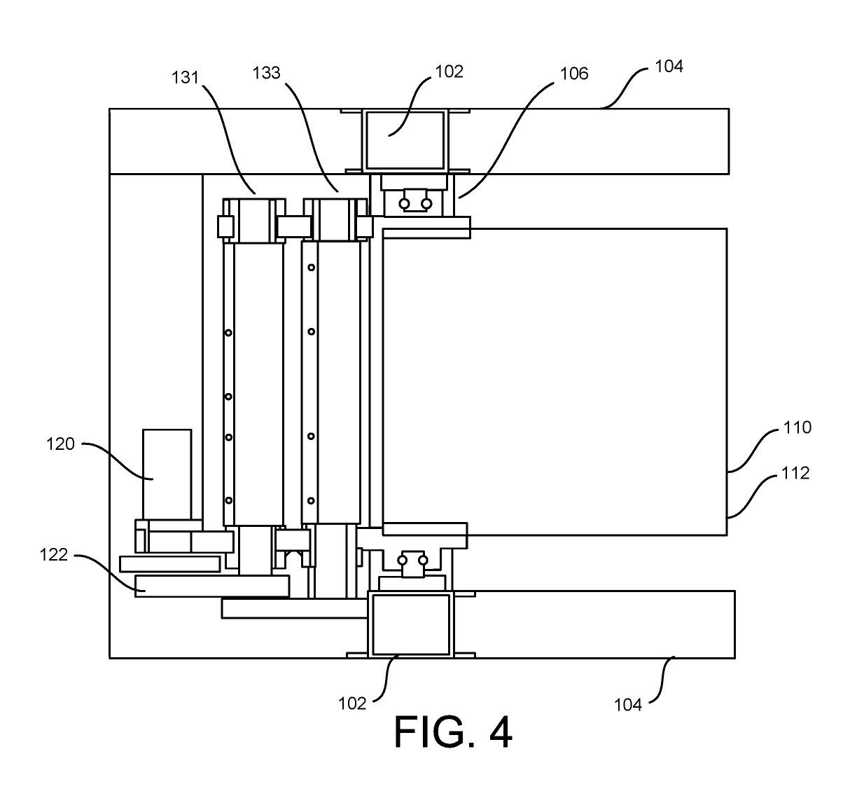

The present invention comprises a novel system 100 (sometimes hereinafter called the “Easy Patient LiftTM” or “EPLTM”) for safe and secure mechanized lifting and lowering of a patient 190 from and onto a hospital bed 192 and for the safe transportation of the patient 190 within the hospital or other facility. With reference to FIGS. 1, 3, and 4, the system 100 comprises a frame (which frame comprises a plurality of vertical supports 102, a plurality of wheel supports 104, and a plurality of horizontal members 106) made of stainless steel, carbon fiber, and/or other suitable synthetic materials supported on a plurality of wheels 108, wherein the wheels 108 may or may not be motorized. It has been found advantageous to have the frame be about 6-7 feet wide (i.e., that is the approximate length of the plurality of horizontal members 106) and about 3-4 feet long (i.e., that is the approximate length of the plurality of wheel supports 104). The height of the plurality of vertical supports 102 is, it has been found advantageous, about 4-5 feet from the ground. The wheelbase (i.e., the distance between the plurality of wheel supports 104 on each side of the frame) should be, it has been found advantageous, adjustable between about 5-7 feet, to allow the plurality of wheel supports 104 to fit either under the hospital bed 192 or around the outside of the bed 192 legs 196, depending on a given bed 192 and the layout and size of the room in which the bed 192, or other patient-care item onto which the patient 190 is to be moved or removed, is located.

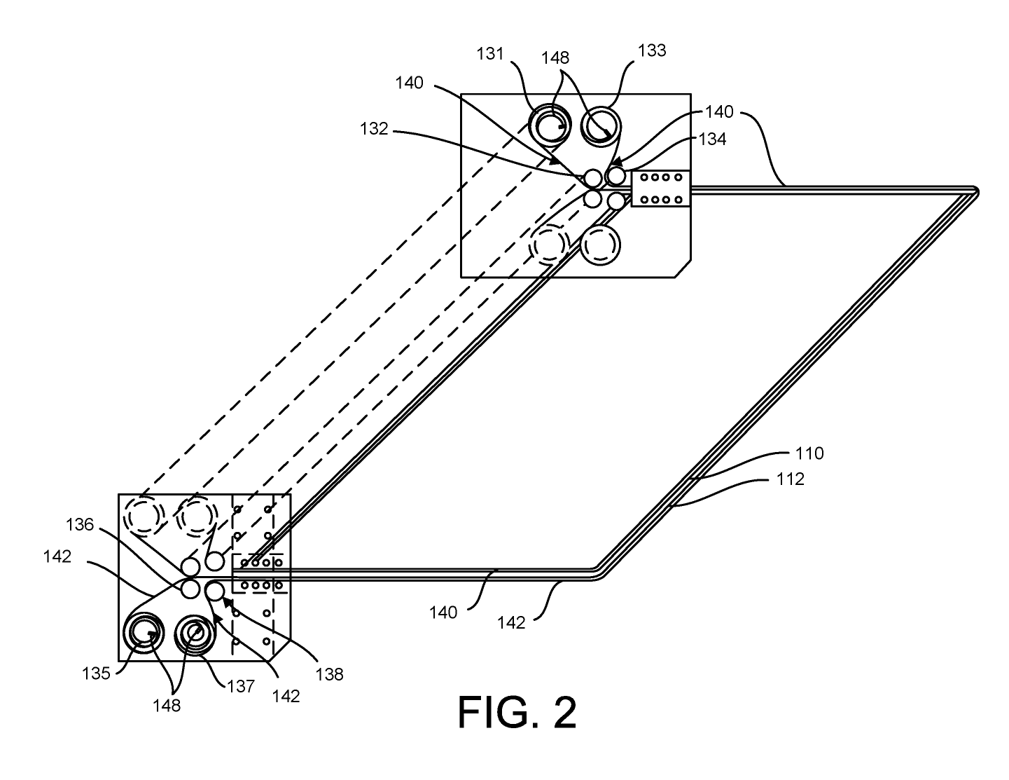

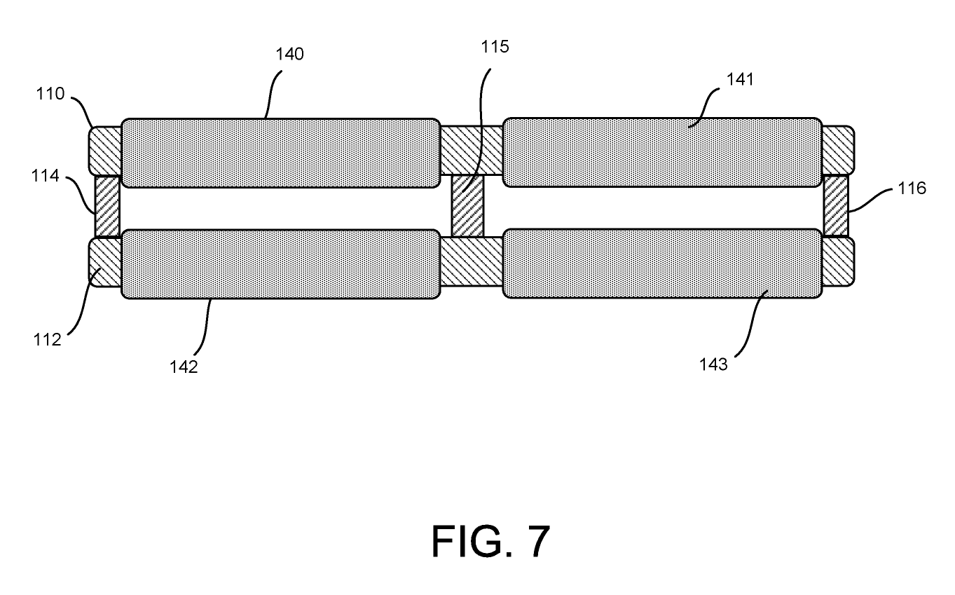

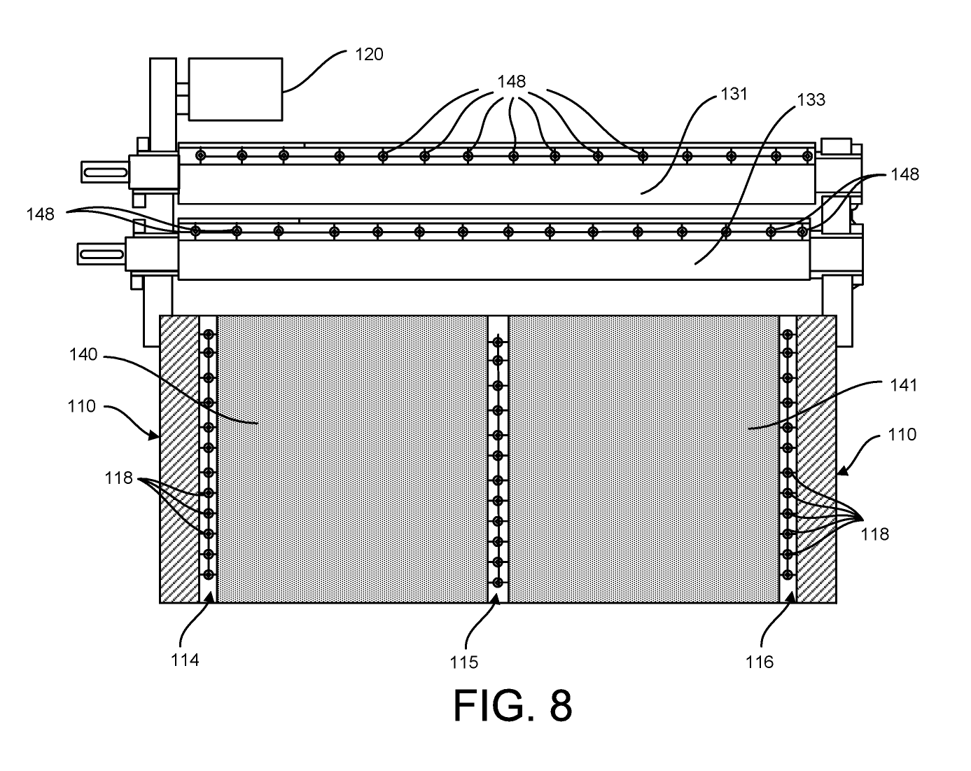

With reference to FIGS. 1, 2, 4, 5, 6, 7, and 8, the plurality of vertical supports 102 supports two rigid flat plates—a top plate 110 and a bottom plate 112—disposed parallel to each other and to the ground, also constructed from stainless steel, carbon fiber and/or other suitable synthetic materials, of sufficient strength, dimensions and thickness to support the size and weight of patients 190 with different physical dimensions and weights (see FIG. 1). The top plate 110 and bottom plate 112 are attached to the plurality of vertical supports 102 in such a way that the top plate 110 and bottom plate 112 can be raised or lowered as a unit using a plurality of electric motors 120, or in some embodiments of the present invention, powered manually. It has been found advantageous to have the top plate 110 and bottom plate 112 be approximately 6-7 feet long and about 3-4 feet wide.

The top plate 110 and bottom plate 112 are attached to the plurality of vertical supports 102, closely spaced (approximately 0.5-1.0 inches apart) and parallel to each other and horizontal, i.e. parallel to the floor (see FIGS. 1, 2, 5, 6, and 7). The top plate 110 and bottom plate 112 may be set at about the height of a typical hospital bed 192 from the floor (i.e. approximately 3-4 feet); which bed 192 may comprise a mattress 194 and legs 196. It has been found advantageous to have the top plate 110 and bottom plate 112 be movable up and down relative to the plurality of vertical supports 102 by about 10-15 inches. It has been found advantageous to have a first plate spacer 114 and a second plate spacer 116 disposed between the top plate 110 and bottom plate 112, running from a proximal end of the plates near the system 100 frame, to the distal end of the plates, and located at or near the side edges of the plates. The spacers support the plates and keep the top plate 110 from deflecting downwards, under the weight of a patient 190, onto the bottom plate 112, which would cause the conveyor belts to be pinched between the plates. In some embodiments of the present invention, there may be a third plate spacer 115 disposed parallel to the other spacers (i.e. running from a proximal edge of the plates to a distal edge of the plates), and in the middle of the plates in a direction from one side edge of the plates to the other side edge of the plates. Embodiments of the present invention with a third plate spacer 115 may be embodiments with more than one conveyor belt per plate, as described below, but are not necessarily so. Each of the plurality of spacers is attached to the top plate 110 and bottom plate 112 with a plurality of suitable plate-spacer connectors 118, the tops of which should be flush with or below the top surface of the top plate 110.

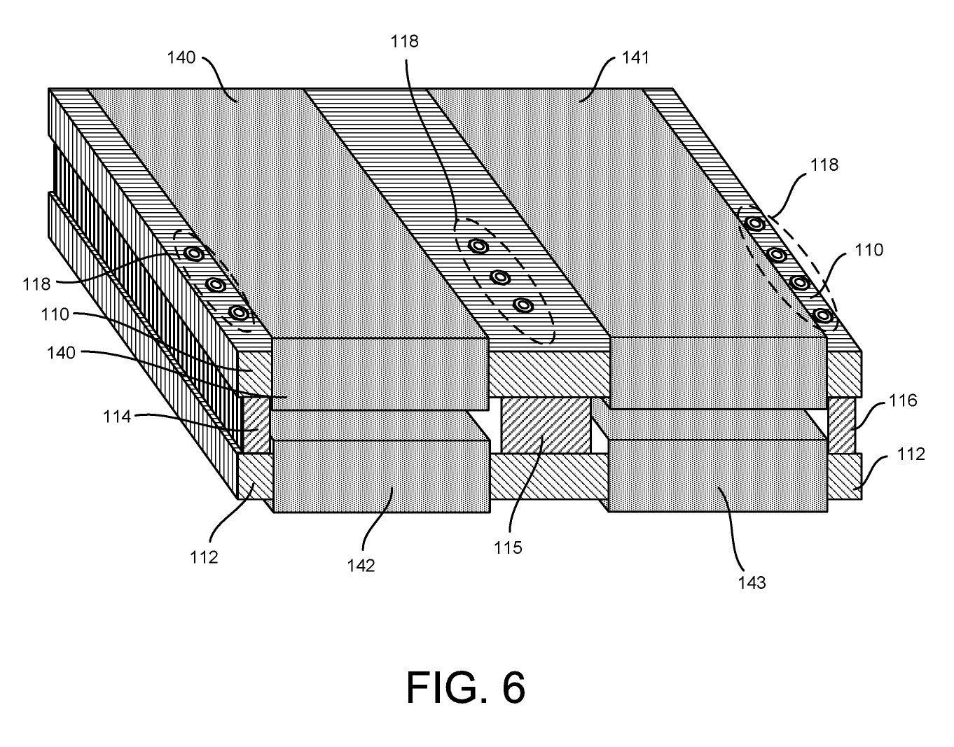

It has been found advantageous to have each plate have a separate flexible conveyor belt that covers the full width of each plate: a first top conveyor belt 140 on the top plate 110 and a first bottom conveyor belt 142 on the bottom plate 112 (see FIGS. 1, 2, 5, 6, 7, and 8). In some embodiments of the present invention, there may be a first top conveyor belt 140 and a second top conveyor belt 141 on the top plate 110, and a first bottom conveyor belt 142 and a second bottom conveyor belt 143 on the bottom plate 112 (see FIGS. 6, 7, and 8). In this disclosure of the present invention, it will be obvious to one of skill in the art that when reference is made to the first top conveyor belt 140, it encompasses a plurality of top conveyor belts, including but not limited to a first top conveyor belt 140, a second top conveyor belt 141, and potentially more top conveyor belts. Likewise, reference to the first bottom conveyor belt 142 encompasses a plurality of bottom conveyor belts, including but not limited to a first bottom conveyor belt 142, a second bottom conveyor belt 143, and potentially more bottom conveyor belts. Each conveyor belt may have its own electric stepper motor 120 for moving that conveyor belt, or may be operated manually. In some embodiments of the present invention, the first top conveyor belt 140 may be padded, or the top plate 110 may have disposed above its top surface and below the first top conveyor belt 140 some pad or padding to add to the comfort of the patient 190, and/or to reduce the risk of irritation or injury to the patient 190.

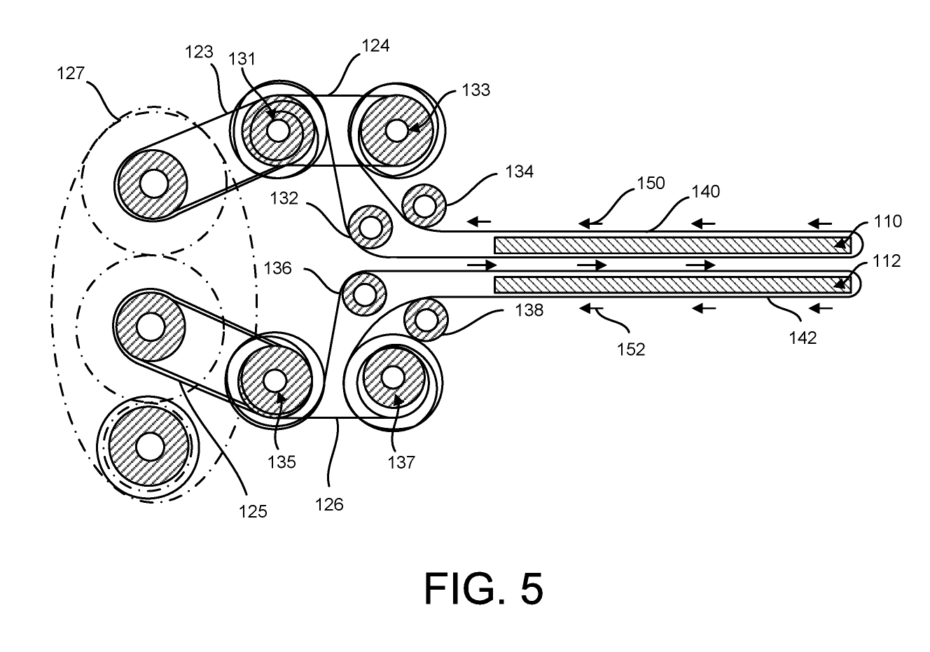

With reference to FIGS. 1 and 5, both the first top conveyor belt 140 and the first bottom conveyor belt 142, or the plurality of conveyor belts, can run in both directions, either clockwise or counterclockwise, so that the upper surface of the first top conveyor belt 140 can be moved either away from the plurality of vertical supports 102 or towards the plurality of vertical supports 102 i.e. in a direction indicated as top conveyor belt above-plate movement direction 150 or in the opposite direction thereto; and so that the lower surface of the first bottom conveyor belt 142 can be moved either away from the plurality of vertical supports 102 or towards the plurality of vertical supports 102, i.e. in a direction indicated as bottom conveyor belt below-plate movement direction 152 or in the opposite direction thereto. The portion of the plurality of conveyor belts that is between the plates will move in a conveyor belt inter-plate movement direction 154, which is necessarily opposite to the respective directions of the top conveyor belt above-plate movement direction 150 and the bottom conveyor belt below-plate movement direction 152, and which may be the direction opposite to that labeled as the conveyor belt inter-plate movement direction 154, as will be obvious to one of skill in the art. It has been found advantageous to have the first top conveyor belt 140 and the first bottom conveyor belt 142 be movable either clockwise or counterclockwise, and be movable independently of one another, in which case the conveyor belt inter-plate movement direction 154 may be different for the plurality of top belts from the plurality of bottom belts.

With reference to FIGS. 1, 2, 4, 5, and 8, the conveyor belts are attached to uptake rollers and guided by guide rollers, which are driven by drive belts which may be operated by a single motor 120, by multiple motors 120, or manually. The conveyor belt on each plate runs independently using its own rollers in two directions, either clockwise or counterclockwise. Note that the lower surface of the first top conveyor belt 140 (the portion of that belt that is underneath the top plate 110) does not contact the upper surface of the first bottom conveyor belt 142 (the portion of that belt that is above the bottom plate 112).

The first top conveyor belt 140 is attached at a first end to a first top belt uptake roller 131 by a plurality of conveyor belt roller attachments 148, and may be wound around that first top belt uptake roller 131. The first top conveyor belt 140 is routed around a first top belt guide roller 132 and then under the top plate 110, around the outboard edge of the top plate 110, and back towards the frame over the top surface of the top plate 110. The first top conveyor belt 140 is then routed around a second top belt guide roller 134 to a second top belt uptake roller 133, to which the first top conveyor belt 140 is attached at a second end (opposite to its first end) by a plurality of conveyor belt roller attachments 148, and around which second top belt uptake roller 133 the first top conveyor belt 140 may be wound.

The first bottom conveyor belt 142 is attached at a first end to a first bottom belt uptake roller 135 by a plurality of conveyor belt roller attachments 148, and may be wound around that first bottom belt uptake roller 135. The first bottom conveyor belt 142 is routed around a first bottom belt guide roller 136 and then over the bottom plate 112, around the outboard edge of the bottom plate 112, and back towards the frame under the bottom surface of the bottom plate 112. The first bottom conveyor belt 142 is then routed around a second bottom belt guide roller 138 to a second bottom belt uptake roller 137, to which the first bottom conveyor belt 142 is attached at a second end (opposite to its first end) by a plurality of conveyor belt roller attachments 148, and around which second bottom belt uptake roller 137 the first bottom conveyor belt 142 may be wound.

The conveyor belt roller attachments 148 may be screws, or a clamped bar or bars, or any of the uptake rollers may be configured with a portion that can open, have an end of a conveyor belt inserted, and then clamped down to hold that end of the conveyor belt.

It will be obvious to one of skill in the art that other configurations of uptake rollers and guide rollers are possible, with other routing arrangements. It has been found advantageous, when more than one conveyor belt is used per plate, to have side guards arranged on the uptake rollers and/or on the guide rollers, so that the first bottom conveyor belt 142 and the second bottom conveyor belt 143 are guided and spooled to proper places on the various rollers, so that, for instance, they do not catch or become snarled or fouled; and likewise for the top conveyor belts and rollers.

The system 100 may then be operated, with the motor 120 or other means of operating the apparatus being used to drive the primary drive belt 122, which then drives a drive transfer assembly 127 to control the top uptake rollers and/or bottom uptake rollers. The drive transfer assembly 127 moves the first top belt uptake roller 131 and the second top belt uptake roller 133 by a driveable connection with a first top rollers drive belt 123 and a second top rollers drive belt 124; and the drive transfer assembly 127 moves the first bottom belt uptake roller 135 and the second bottom belt uptake roller 137 through a driveable connection with a first bottom rollers drive belt 125 and a second bottom rollers drive belt 126. The top rollers and the bottom rollers may, it has been found advantageous, be operated independently of each other, and may be operated manually or with suitable electric or electronic controls, including but not limited to a variable-speed dial or electronic buttons and digital control system. The first top belt uptake roller 131 and the second top belt uptake roller 133 may be operated to drive the first top conveyor belt 140 in the indicated top conveyor belt above-plate movement direction 150, or in the direction opposite to the indicated top conveyor belt above-plate movement direction 150. Likewise, the first bottom belt uptake roller 135 and the second bottom belt uptake roller 137 may be operated to drive the first bottom conveyor belt 142 in the indicated bottom conveyor belt below-plate movement direction 152, or in the direction opposite to the indicated bottom conveyor belt below-plate movement direction 152.

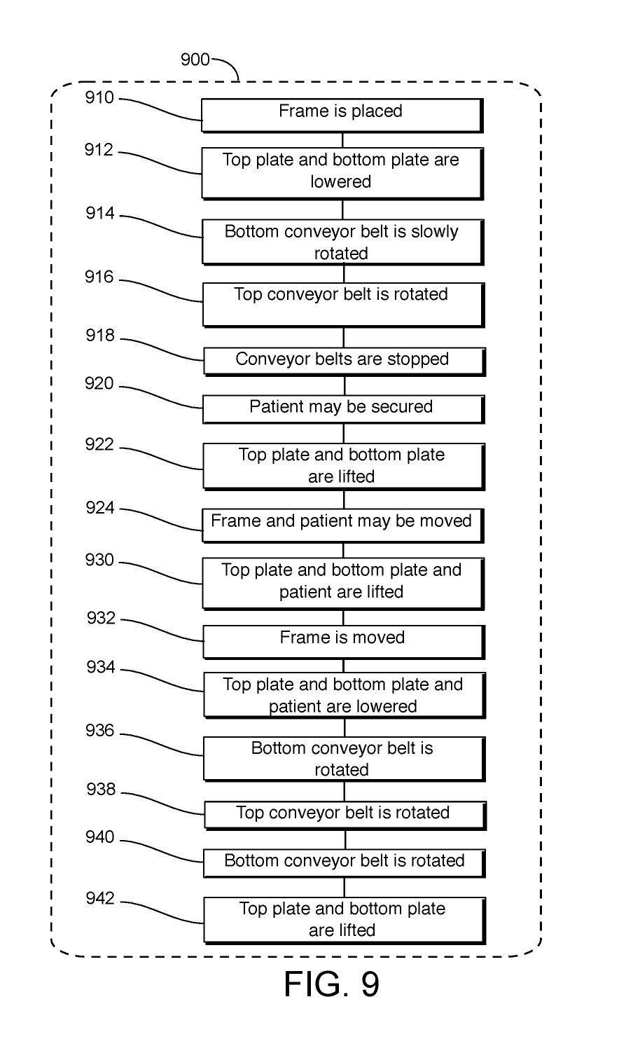

With reference to FIG. 9, in operation, an inventive method 900 of operation of the inventive system 100 comprises the following steps. The frame is placed 910 with the plurality of horizontal members 106 parallel to the patient's bed 192 in such way that the outboard ends (the ends distal to the plurality of vertical supports 102 of the frame) of the top plate 110 and bottom plate 112 are set a short distance over the upper edge of the mattress 194 of the bed 192. Then the top plate 110 and bottom plate 112 are lowered 912 as a unit to engage and slightly compress the mattress 194, as depicted in FIG. 1. Then the first bottom conveyor belt 142 is slowly rotated 914 clockwise in this depiction to slowly move the top plate 110 and bottom plate 112 (and the frame) towards the patient 190, by gripping and pulling on the mattress 194. As the top plate 110 and bottom plate 112 reach the patient 190, the first top conveyor belt 140 is rotated 916 counterclockwise in this depiction, at a speed synchronized to the speed of the first bottom conveyor belt 142, so that the patient 190 is pulled on to the first top conveyor belt 140 and towards the plurality of vertical supports 102. Once the patient 190 is safely positioned in the middle of the top plate 110, all conveyor belts are stopped 918.

The patient 190 may be secured 920 by lowering a safety barrier comprising a first side guard arm 170 located above one side edge of the plates; a second side guard arm 172 located above the side edge of the plates opposite to the first side guard arm 170, the guard arms being attached at their proximal ends to the frame of the system; a distal guard rail 174 attached to the first side guard arm 170 and to the second side guard arm 172 at an end of each guard arm distal to the plurality of vertical supports 102, and running perpendicular to the guard arms and parallel to the plurality of horizontal members 106; and the safety barrier being movably attached to the frame with a rotational movement up and down as indicated by guard assembly movement 176. Then the top plate 110 and bottom plate 112 are lifted 922 as a unit so that they no longer engage the mattress 194. The frame, plates and the patient 190 can be moved 924 and transported throughout the hospital or other facility.

When the patient 190 is to be moved onto a bed 192 (e.g., the same or another bed 192, or to a different location or patient-care facility, such as an X-ray or MRI machine), the reverse process is used; i.e., the top plate 110 and bottom plate 112 (and patient 190) are lifted 930 on the plurality of vertical supports 102 so that the top plate 110 and bottom plate 112 sit above the mattress 194 or other item that the patient 190 is to be positioned on, the frame is moved 932 so that the outboard ends of the top plate 110 and bottom plate 112 sit a short distance over the upper edge of the bed 192, and the top plate 110 and bottom plate 112 and patient 190 are lowered 934 so that the first bottom conveyor belt 142 engages the mattress 194. Then the first bottom conveyor belt 142 is rotated 936 clockwise as depicted in FIGS. 1, 2, and 5, so that the top plate 110 and bottom plate 112, together with the frame of the system 100, are moved towards the center of the bed 192. Upon reaching the desired location, the first top conveyor belt 140 is rotated 938 clockwise as depicted in FIGS. 1, 2, and 5 so as to move the patient 190 off the first top conveyor belt 140 and onto the middle of the bed 192, and for part of the time that the first top conveyor belt 140 is being rotated 938 clockwise to move the patient 190 off of the top plate 110 and onto the bed 192, the first bottom conveyor belt 142 is rotated 940 counterclockwise at a speed synchronized to the speed of the first top conveyor belt 140 to withdraw the plates out from under the patient 190 and off of the bed 192, gently depositing the patient 190 onto the bed 192 or other patient-care location or item. When the patient 190 is fully off of the top plate 110 of the system 100, the top plate 110 and bottom plate 112 are lifted 942 off the mattress 194, whereupon the system 100 is removed from the patient 190 and bed 192.

Certain embodiments of the present invention were described above. From the foregoing it will be seen that this invention is one well adapted to attain all the ends and objects set forth above, together with other advantages, which are obvious and inherent to the system 100 and method 900. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A system for lifting and lowering of a patient and for safe transportation of the patient, the system comprising:
a frame which further comprises a plurality of vertical supports, a plurality of wheel supports, a plurality of horizontal members, and a plurality of wheels;
a top plate and a bottom plate supported by the plurality of vertical supports, which top plate and bottom plate can be raised or lowered as a unit, and which top plate and bottom plate are closely spaced and parallel to each other and horizontal;
a first top conveyor belt on the top plate, attached at a first end to a first top belt uptake roller by a plurality of conveyor belt roller attachments, routed around a first top belt guide roller, then under the top plate, then over the top surface of the top plate, then routed around a second top belt guide roller to a second top belt uptake roller, to which the first top conveyor belt is attached at a second end by a plurality of conveyor belt roller attachments;
a first bottom conveyor belt on the bottom plate, attached at a first end to a first bottom belt uptake roller by a plurality of conveyor belt roller attachments, routed around a first bottom belt guide roller, then over the bottom plate, then under the bottom surface of the bottom plate, then routed around a second bottom belt guide roller to a second bottom belt uptake roller, to which the first bottom conveyor belt is attached at a second end by a plurality of conveyor belt roller attachments; and
in which the conveyor belts can be independently run in both directions.

2. The system of claim 1, in which the approximate length of the plurality of wheel supports is about 3-4 feet.

3. The system of claim 1, in which the approximate height of the plurality of vertical supports is about 4-5 feet.

4. The system of claim 1, in which the distance between the plurality of wheel supports is adjustable between about 5-7 feet.

5. The system of claim 1, in which the top plate and bottom plate are approximately 6-7 feet long and about 3-4 feet wide.

6. The system of claim 1, in which the top plate and bottom plate are movable up and down relative to the plurality of vertical supports by about 10-15 inches.

7. The system of claim 1, in which a first plate spacer and a second plate spacer are disposed between the top plate and the bottom plate, and each of the plate spacers is attached to the top plate and bottom plate with a plurality of plate-spacer connectors.

8. The system of claim 7, in which the first plate spacer and the second plate spacer are configured from a proximal end of the plates near the frame, to a distal end of the plates, and located at or near the side edges of the plates.

9. The system of claim 7, further comprising a third plate spacer disposed between the top plate and the bottom plate, and parallel to the first plate spacer and the second plate spacer, and in the middle of the plates, and attached to the top plate and bottom plate with a plurality of plate-spacer connectors.

10. The system of claim 1, further comprising a second top conveyor belt on the top plate, and a second bottom conveyor belt on the bottom plate.

11. The system of claim 1, in which the first top conveyor belt is padded.

12. The system of claim 1, in which a pad is disposed on the top plate above its top surface and below the first top conveyor belt.

13. The system of claim 1, in which the conveyor belts may be motorized, with the system further comprising a motor, a primary drive belt, a drive transfer assembly, a first top rollers drive belt, a second top rollers drive belt, a first bottom rollers drive belt, and a second bottom rollers drive belt, collectively the drive belts, which drive belts are engaged by the motor.

14. The system of claim 1, further comprising a safety barrier comprising a first side guard arm; a second side guard arm, the guard arms being attached at their proximal ends to the frame; and a distal guard rail attached to the guard arms.

15. A system for lifting and lowering of a patient and for safe transportation of the patient, the system comprising:
a frame;
a top plate and a bottom plate, which top plate and bottom plate can be raised or lowered as a unit, and which top plate and bottom plate are closely spaced and parallel to each other and horizontal, and which top plate and bottom plate have disposed between them a plurality of plate spacers, which are attached to both plates;
a plurality of top conveyor belts on the top plate, attached at a first end to a first top belt uptake roller by a plurality of conveyor belt roller attachments, routed around a first top belt guide roller, then under the top plate, then over the top surface of the top plate, then routed around a second top belt guide roller to a second top belt uptake roller, to which the first top conveyor belt is attached at a second end by a plurality of conveyor belt roller attachments;
a plurality of bottom conveyor belts on the bottom plate, attached at a first end to a first bottom belt uptake roller by a plurality of conveyor belt roller attachments, routed around a first bottom belt guide roller, then over the bottom plate, then under the bottom surface of the bottom plate, then routed around a second bottom belt guide roller to a second bottom belt uptake roller, to which the first bottom conveyor belt is attached at a second end by a plurality of conveyor belt roller attachments; and
in which the plurality of top conveyor belts and the plurality of bottom conveyor belts can be independently run in both directions.

16. The system of claim 15, in which the pluralities of conveyor belts may be motorized, with the system further comprising a motor, a primary drive belt, a drive transfer assembly, a first top rollers drive belt, a second top rollers drive belt, a first bottom rollers drive belt, and a second bottom rollers drive belt, collectively the drive belts, which drive belts are engaged by the motor.

17. A method for lifting and lowering of a patient and for safe transportation of the patient, the method comprising:
placing the frame with the plurality of horizontal members parallel to the bed, with the top plate and bottom plate a short distance over the upper edge of the bed; then
the top plate and bottom plate are lowered; then
the first bottom conveyor belt is rotated; then
the first top conveyor belt is rotated; then
all conveyor belts are stopped; and then
the top plate and bottom plate are lifted.

18. The method of claim 17, the method further comprising, when the first top conveyor belt is rotated, the first bottom conveyor belt is rotated at a speed synchronized to the speed of the first top conveyor belt to withdraw the plates out from under the patient.

19. The method of claim 17, the method further comprising securing the patient by lowering a safety barrier.

20. The method of claim 17, the method further comprising moving the frame and plates with the patient.
